(19) United States
(12) Patent Application Publication
(10) Pub. No.: US 2024/0059994 A1
(43) Pub. Date: Feb. 22, 2024

(54) HIGH-QUALITY COKE PRODUCTS

(71) Applicant: SUNCOKE TECHNOLOGY AND DEVELOPMENT LLC, Lisle, IL (US)

(72) Inventors: John Francis Quanci, Haddonfield, NJ (US); Jonathan Perkins, Lisle, IL (US)

(21) Appl. No.: 18/363,465

(22) Filed: Aug. 1, 2023

Related U.S. Application Data
(62) Division of application No. 17/306,895, filed on May 3, 2021, now Pat. No. 11,767,482.
(60) Provisional application No. 63/019,405, filed on May 3, 2020.

(51) Int. Cl. C10L 5/36; C10L 5/04

(52) U.S. Cl. CPC C10L 5/36; C10L 5/04; Y02E 50/10

(57) ABSTRACT

High quality coke products made in horizontal ovens such as heat recovery, non-recovery or Thompson ovens from an optimized coal blend. The coke products have unique properties such as an oblong shape and improved Coke Strength after Reaction (CSR) and Coke Reactivity Index (CRI) properties.

### CROSS-REFERENCE TO RELATED APPLICATION(S)

This application is a continuation of U.S. patent application Ser. No. 17/306,895, filed May 3, 2021, which claims priority to U.S. Provisional Application No. 63/019,405, filed on May 3, 2020, the content of which are incorporated herein by reference in their entireties.

### TECHNICAL FIELD

This disclosure relates to high quality coke products having unique properties made in ovens including horizontal ovens such as heat recovery, non-recovery or Thompson ovens.

### BACKGROUND

Coke is a solid carbon fuel and carbon source used to melt and reduce iron ore in the production of steel. Foundry coke is coke of very large size, usually at least 4 inches in diameter, and of exceptional quality such as very low content of impurities, and very high carbon content, strength, and stability. Foundry coke is used in foundry cupolas to melt iron and produce cast iron and ductile iron products. However, the production cost including the manufacturing cost, transportation cost, and environmental cost, for foundry coke is high. Therefore, there is a need in the art to improve the production process thereby to obtain high quality foundry coke at a higher yield and/or a lower cost. This application satisfies the need by providing a high-quality foundry coke with many unique and improved properties.

### BRIEF DESCRIPTION OF THE DRAWINGS

This application contains at least one drawing executed in color. Copies of this application with color drawing(s) will be provided by the Office upon request and payment of the necessary fees.

FIG. 1 shows the shape, size, and color of HD₊™ foundry coke produced with 10% wt breeze in comparison with commercially available foundry coke. Commercial foundry coke 1 is made in the USA in a conventional byproduct plant, shown on a piece of 8.5 inches×11 inches paper. Commercial foundry coke 2 has extremely high density and is made in a foreign country in a stamp charged byproduct plant, shown on a piece of 8.5 inches×11 inches paper.

FIG. 2 shows the CSR and CRI of HD₊™ foundry coke obtained at 5% wt breeze loading (diamonds) and at 8.5% wt breeze loading (circles) in comparison to the CSR and CRI for regular Met Coke (squares) from literature (Diez et al., International Journal of Coal Geology 50: 389-412 (2002)).

FIGS. 3A-3C show the simulation of packing tests for coke pieces having a uniform size of (10 inches×10 inches) (FIG. 3A), coke pieces having a uniform size of (4 inches×10 inches) (FIG. 3B), and coke pieces having random sizes (FIG. 3C).

FIG. 4 shows variability from repeat runs from stochastic nature of simulation in packing tests for cupola.

FIG. 5 shows an example of the calculation of hydraulic radius and an example of user's output of the calculation.

### DETAILED DESCRIPTION

Disclosed herein are high quality HD₊™ coke products, in particular, HD₊™ foundry coke having unique properties. The coking process produces coke products of various sizes in different fractions. Conventionally, the coke products have a substantially round shape and are classified based on size: foundry coke having a size of larger than 4 inches in diameter, egg (industrial coke) having a size of 2-4 inches, stove having a size of 1-2 inches or 1-1.5 inches, nut having a size of ⅜-1 inch, and breeze having a size of less than ⅜ inch. According to aspects of this disclosure, the HD₊™ coke products disclosed herein are produced by a proprietary coking process using a predetermined coal blend including certain percentage of inerts or breeze in a horizontal oven such as a heat recovery oven, a non-recovery oven, or a Thompson oven. The HD₊™ coke products can be classified differently. In one example, the HD₊™ coke products include HD₊™ foundry coke having a hydraulic diameter of over 3.5 inches, HD₊™ egg coke having a hydraulic diameter of 1.5-3.5 inches, HD₊™ breeze having a hydraulic diameter of 0.5-1.5 inches, and HD₊™ waste fines having a size of less than 0.5 inch. All HD₊™ breeze can be crushed to less than ⅜ inch and recycled to coal blend for the coking process, while waste fines may impose an issue with heat recovery due to potential burn loss and high ash content. Therefore, some or all waste fines are recycled depending on the coking process. HD₊™ eggs are only recycled if additional breeze loading is required but mostly, HD₊™ eggs can be sold and used in sugar beet and mineral wool or rock wool production.

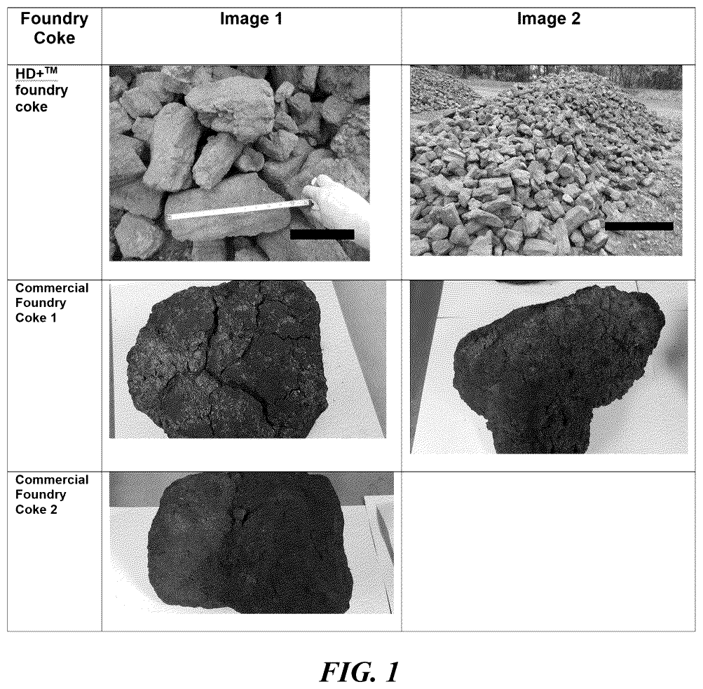

In certain embodiments, disclosed herein is HD₊™ coke having a shape distinguishable from commercially available foundry coke, which has a substantially round shape and a diameter of at least 4 inches. Unlike the conventional round-shaped, black foundry coke, the HD₊™ foundry coke disclosed herein has an oblong “finger-shape”, as shown in FIG. 1. In certain embodiments, the HD₊™ coke disclosed herein has a gray or light gray color.

In certain embodiments, the HD₊™ foundry coke has a high aspect ratio of length to width. For example, the HD₊™ foundry coke has a length between 2 and 36 inches, between 3 and 15 inches, between 4 and 12 inches, or between 4 and 10 inches and a width between 1.5 and 12 inches, between 2 and 8 inches, between 3 and 7 inches, between 2 and 4 inches, or between 4 and 6 inches. In some embodiments, the HD₊™ foundry coke has a length of at least 2 inches, at least 3 inches, at least 4 inches, at least 5 inches, at least 6 inches, at least 7 inches, at least 8 inches, at least 9 inches, at least 10 inches, at least 11 inches, at least 12 inches, at least 13 inches, at least 14 inches, at least 15 inches, at least 16 inches, at least 17 inches, at least 18 inches, at least 19 inches, at 20 inches, at least 21 inches, at least 22 inches, at least 23 inches, at least 24 inches, at least 25 inches, at least 26 inches, at least 27 inches, at least 28 inches, at least 29 inches, at least 30 inches, at least 31 inches, at least 32 inches, at least 33 inches, at least 34 inches, at least 35 inches, or at least 36 inches. In some embodiments, the HD₊™ foundry coke has a width of at least 1.5 inches, at least 2 inches, at least 3 inches, at least 4 inches, at least 5 inches, at least 6 inches, at least 7 inches, at least 8 inches, at least 9 inches, at least 10 inches, at least 11 inches, at least 12 inches, at least 13 inches, at least 14 inches, at least 15 inches, at least 16 inches, at least 17 inches, at least 18 inches. In certain embodiments, the HD₊™ foundry coke has a length:width ratio of at least 1.1, at least 1.5, at least 2.0, at least 2.5, at least 3.0, at least 3.5, at least 4.0, at least 4.5, at least 5.0, at least 5.5, at least 6.0, at least 6.5, at least 7.0, at least 7.5, at least 8.0, at least 8.5, at least 9.0, at least 9.5, or at least 10.0. In some embodiments, the HD₊™ foundry coke has a length-width ratio of at least 2.0, at least 3.0, or at least 4.0.

In certain embodiments, the HD₊™ foundry coke is produced in a horizontal oven such as a heat recovery, non-recovery or Thompson oven by a proprietary process. In certain embodiments, at least 30%, at least 35%, at least 40%, at least 45%, at least 50%, at least 55%, at least 60%, at least 65%, at least 70%, at least 75%, at least 80%, at least 85%, at least 90%, at least 95%, at least 98%, or at least 99% of the total coke from a single production process or a single oven falls within the ranges of the length, width, and the ratio of length:width disclosed above. In certain embodiments, at least 40%, at least 45%, at least 50%, at least 55%, at least 60%, at least 65%, at least 70%, at least 75%, at least 80%, at least 85%, at least 90%, at least 95%, at least 98%, or at least 99% of the total foundry coke from a single production process falls or a single oven within the ranges of the length, width, and the ratio of length:width disclosed above.

In certain embodiments, the HD₊™ foundry coke has a hydraulic diameter (Dh) larger than its actual or effective diameter; whereas the conventional round-shaped foundry coke has a Dh substantially the same as the actual diameter. Dh is a function of hydraulic radius (Rh), which is defined as follows:

$$R h = \frac{ε b D p}{6 ( 1 - ε b )}$$

εb is the interparticle porosity of the coke bed, calculated as follows:

$$ε b = 1 - \frac{ρ b}{ρ a}$$

where ρb is the bulk density and pa is the apparent density of coke.

Dp is the harmonic mean particle diameter. Dp represents the size of a uniform coke that has the same surface-to-volume ratio as a nonuniform coke, calculated as follows:

$$Dp = \frac{1}{{\sum }_{i} \frac{fi}{Di}}$$

where fi is the weight fraction of the coke charge having a diameter Di. For uniform size coke, Dp=Di.

In certain embodiments, the HD₊™ foundry coke has a hydraulic diameter of at least 2 inches, at least 2.5 inches, at least 3 inches, at least 3.5 inches, at least 4 inches, at least 4.5 inches, at least 5 inches, at least 5.5 inches, at least 6 inches, at least 6.5 inches, at least 7 inches, at least 7.5 inches, at least 8 inches, at least 8.5 inches, at least 9 inches, at least 9.5 inches, at least 10 inches, at least 10.5 inches, at least 11 inches, at least 11.5 inches, at least 12 inches, at least 12.5 inches, at least 13 inches, at least 13.5 inches, at least 14 inches, at least 14.5 inches, at least 15 inches, at least 15.5 inches, at least 16 inches, at least 16.5 inches, at least 17 inches, at least 17.5 inches, or at least 18 inches. In certain embodiments, the HD₊™ egg has a hydraulic diameter of between 1.5 and 3.5 inches or between 1.5 and 2 inches.

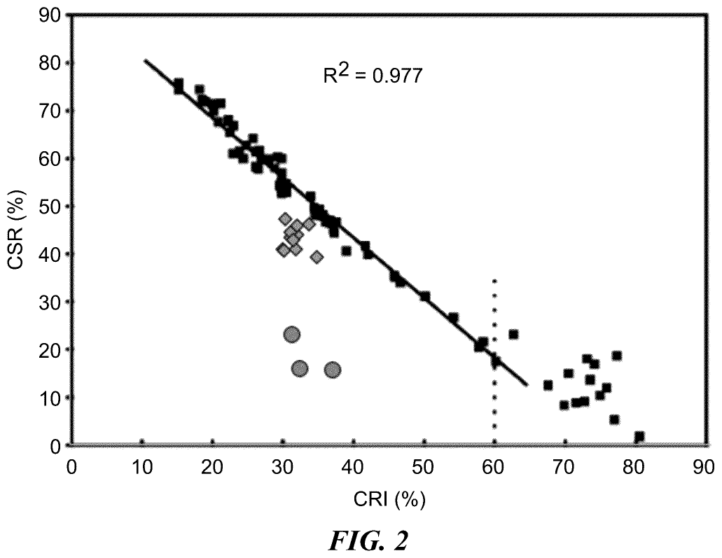

Coke Reactivity Index (CRI) represents the percentage of weight loss after Boudouard reaction: CO₂+C_{(coke)}=2CO in heated kiln for 2 hours. Coke Strength after Reaction (CSR) is based on a tumble strength test of coke remaining after the CRI kiln reaction. Boudouard reaction occurring at the surface of foundry coke in a cupola is undesirable because the reaction steals heat from iron melting and makes the process less efficient. Thus, a lower CRI is desirable such that the coke is inert enough to resist the Boudouard reaction. On the other hand, the CRI cannot be too low such that the coke is inert to resist combustion. As shown in FIG. 2, CSR and CRI has an inverse correlation. The conventional foundry coke has a CSR of between 10% and 15%, which correlates to a high CRI of at least 60%.

Unless specified otherwise, all percentages disclosed in this document refer to weight percentage. In certain embodiments, the HD₊™ foundry coke disclosed herein has a CSR between 5% and 60%, between 5% and 50%, between 15% and 50%, or between 15% and 40%. In certain embodiments, the HD₊™ coke has a CRI less than 40%, between 20% and 45%, between 25% and 40%, or between 31% and 37%. The percentage of breeze loading during the coking process affects the CSR of the HD₊^{T}m coke, where a higher breeze loading results in a decrease in CSR, shown in FIG. 2. According to aspects of the disclosure, CRI remains low even when CSR is significantly increased. According to one embodiment of the disclosure, HD₊™ coke disclosed herein has a combination of a low CRI such as between 25% and 40% and a mid- to high-range CSR such as between 15% and 50%.

In certain embodiments, the HD₊™ egg has the same or substantially the same CSR as the HD₊™ foundry coke disclosed above. In certain embodiments, the HD₊™ egg has the same or substantially the same CRI as the HD₊™ foundry coke disclosed above.

After production from the oven, the HD₊™ foundry coke is subject to quality control and screening before shipping and delivering to a customer. As used herein, the term “pre-processed” coke products means that the coke products are freshly produced from the oven and before screening, shipping and delivering to a customer; while the term “processed” coke products means that the coke products have been subjected to the process of screening, shipping, and delivering to a customer. In certain embodiments, the pre-processed HD₊™ foundry coke has a 4-inch drop shatter of at least 30%, at least 35%, at least 40%, at least 45%, at least 50%, at least 55%, at least 60%, at least 65%, at least 70%, at least 75%, at least 80%, at least 85%, or at least 90% when using starting materials having a size of at least 4 inches for the industry standard drop shatter test. In certain embodiments, the pre-processed HD₊™ foundry coke has a 2-inch drop shatter of at least 40%, at least 45%, at least 50%, at least 55%, at least 60%, at least 65%, at least 70%, at least 75%, at least 80%, at least 85%, at least 90%, or at least 95% when using starting materials having a size of at least 4 inches for the industry standard drop shatter test. In certain embodiments, the processed HD₊™ foundry coke has a 4-inch drop shatter of at least 60%, at least 65%, at least 70%, at least 75%, at least 80%, at least 85%, or at least 90% when using starting materials having a size of at least 4 inches for the industry standard drop shatter test. In certain embodiments, the processed HD₊™ foundry coke has a 2-inch drop shatter of at least 80%, at least 85%, at least 90%, or at least 95% when using starting materials having a size of at least 4 inches for the industry standard drop shatter test.

In certain embodiments, the HD₊™ foundry coke has one or more customized references, such as an ash content of between 5% and 12%, less than 10%, less than 9.5%, less than 9%, less than 8.5%, less than 8%, less than 7.5%, or less than 7%; a sulfur content of less than 1%, less than 0.9%, less than 0.8%, less than 0.7%, less than 0.6%, or less than 0.5%; a volatile matter (VM) content of less than 2%, less than 1%, between 0.4% and 1%, about 0.5%, or about 0.3%; a moisture content of less than 15%, less than 10%, less than 9%, less than 8%, less than 7%, less than 6%, less than 5%, less than 4%, less than 3%, less than 2%, less than 1%, or between 1% and 10%; and a fixed carbon content of at least 80%, at least 85%, at least 90%, or at least 95%.

In certain embodiments, the total coke produced by the proprietary process has a size distribution as follows: the HD₊™ foundry coke is at least 40%, at least 45%, at least 50%, at least 55%, at least 60%, at least 65%, at least 70%, at least 75%, or at least 80%, the mid-size coke including the HD₊™ egg and HD₊™ breeze is between 5% and 35%, between 10% and 30%, or between 15% and 20%, the waste fines is less than 10%, less than 8%, or less than 5%. Preferably, the fraction of HD₊™ foundry coke is at a highest possible percentage in the total coke produced.

Due to its unique size and shape, the HD₊™ coke disclosed herein has an advantage of achieving a desirable packing density as demonstrated in the working example below.

### Example 1: Packing Test

This example demonstrates a cupola packing simulation by a simplistic 2D random packing model. Comparing to the uniformly sized coke, coke having a wide size distribution is expected to have a higher bulk density, greater surface area, and lower bed porosity when loaded in an oven.

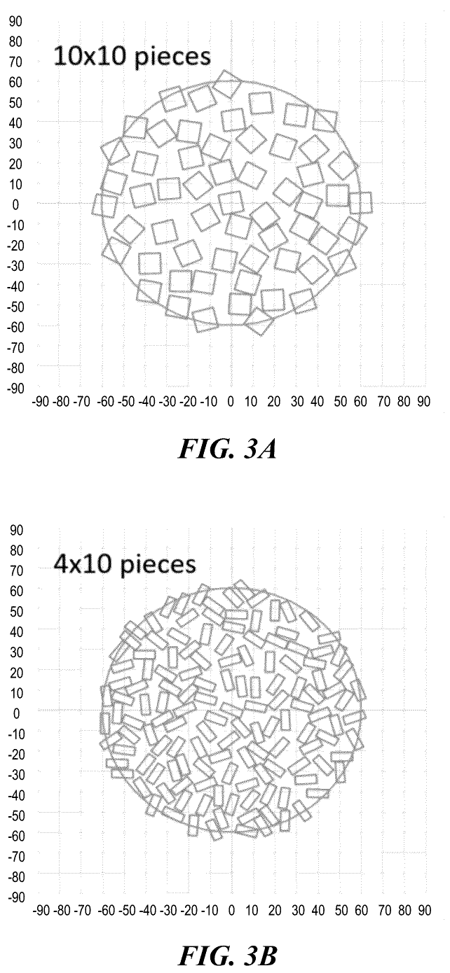

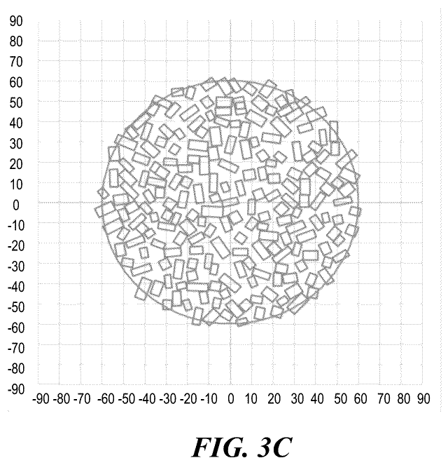

FIG. 3A shows a 2D simulated packing test of coke having a uniform size of 10 inches×10 inches. The circle represents the cross section of a cupola with a radius of 60 inches. Each of the squares represents a piece of foundry coke that is a cube 10 inches on a side. The coke pieces were sequentially attempted to be added in in random locations and with random rotations. If the new coke piece did not overlap with any previous pieces, then it was placed and otherwise discarded. Overlap was determined by the intersection of coke edges. In this particular simulation 10,000 pieces were attempted and only 61 were able to fit in.

The gross assumptions for this model include: (1) the next layer of pieces lays on top of this one; (2) the parts of the coke pieces that extend outside of the circle are ignored as a trivial error; (3) this cross-section is essentially equivalent to any other cross section in the cupola; (4) the relative density of the coke loading is proportional to the ratio of the sum of the areas of the squares to the area of the total circle; and (5) although not exactly accurate, the relative surface area is roughly proportional to the sum of perimeters of the coke pieces.

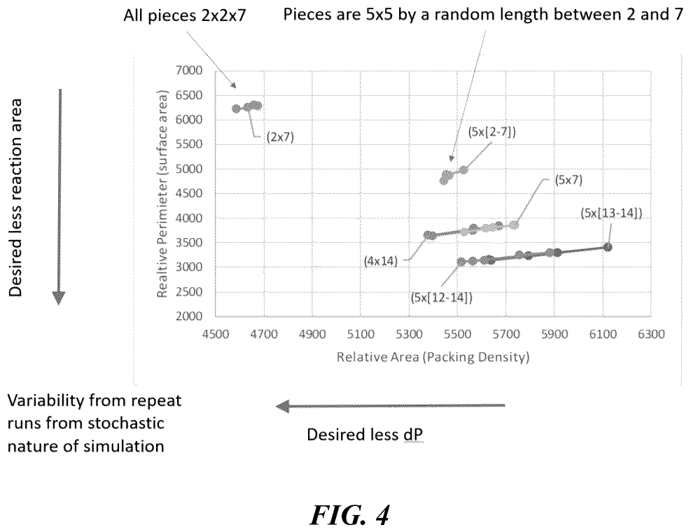

In a side-by-side comparison of fitting 10 inches×10 inches pieces (illustrated in FIG. 3A) and 4 inches×10 inches pieces (illustrated in FIG. 3B), the ratio of the covered area and the sum of perimeters of the coke pieces are compared. For the 10 inches×10 inches pieces, 58 pieces were placed, resulting in a 51% coverage of the cupola area of 11,309 square inches: (10×10×58)/11,309=51%; and a sum of perimeters of 2,320 inches: 2×(10+10)×58=2,320. For the 4 inches×10 inches pieces, 138 pieces were placed, resulting in a 49% coverage of the cupola area of 11,309 square inches: (4×10×138)/11,309=49%; and a sum of perimeters of 3,864 inches: 2×(4+10)×138=3,864.

The next improvement in the simulation was to: (1) Allow variation in the length and width of the coke pieces between a user defined maximum and minimum. Each piece is assumed have a square small end (i.e. L×W×W); and (2) Allow for the piece to tilt so smaller “corners” of the piece can fit in the allowed spaces. When full range of tilt was allowed, the simulation favored standing the pieces on small end. Therefore, the maximum tilt was limited to 30 degrees arbitrarily.

Based on this assumption, coke pieces of various sizes were fitted to cupola radius of 60 inches as shown in FIG. 3C. The coke pieces have a length between 4 inches and 10 inches and a width between 3 inches and 5 inches, and 10,000 attempts were made for the fitting. For the pieces of various sizes, 209 pieces were placed, resulting in a 47% coverage of the cupola area of 11,309 square inches: 5,365/11,309=47%; and a sum of perimeters of 4,383 inches. Therefore, the packing test demonstrates that the relative density of the coke loading did not change significantly, while the relative surface area increased significantly comparing the packing simulations in FIGS. 3A-C. The results are summarized in Table 1 below.

TABLE 1
Coke Pieces Packing Test Results

| | % of coverage area | Sum of perimeters |
|---|---|---|
| Coke Size | (packing density) | (relative surface area) |
| A (10 inches × 10 inches) | 51% | 2320 |
| B (4 inches × 10 inches) | 49% | 3864 |
| C ([3-5 inches] × | 47% | 4383 |
| [4-10 inches]) | | |

FIG. 4 shows variability from repeat runs from stochastic nature of simulation.

### Example 2: Calculation of Hydraulic Radius

An Excel model was used to calculate hydraulic radius of the foundry coke based on its measured size distribution, the presumed bottom screen cut and the bulk density using the formulas disclosed above.

The oblong shape of our coke has the potential to create a sparse packing density which in turn increases the effective hydraulic radius. This in turn makes the cupola performance of the foundry improve due to the reduction of latent heat loss from the reaction of CO₂ and coke to form CO which occurs on the surface of the coke. Higher interstitial volume to coke surface area ratios help on this factor.

Hydraulic radius can also be improved by cutting out the small coke but the yield will be compromised. The oblong coke shape may prove to be a significant cupola performance benefit.

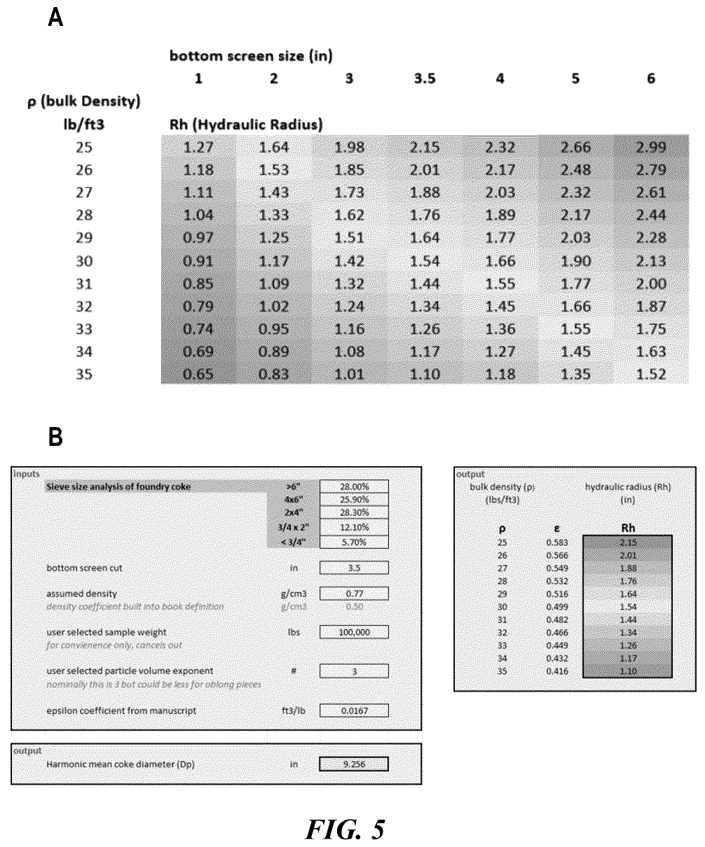

The bulk density of the screened coke, as well as unscreened coke, is measured and can be used in the calculation. The calculation results are shown in FIG. 5.

From the foregoing it will be appreciated that, although specific embodiments of the technology have been described herein for purposes of illustration, various modifications may be made without deviating from the spirit and scope of the technology. Further, certain aspects of the new technology described in the context of particular embodiments may be combined or eliminated in other embodiments. Moreover, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein. Thus, the disclosure is not limited except as by the appended claims.

1. A coke having an oblong shape, wherein the length:width ratio of the coke is at least 1.5.

2. The coke of claim 1, wherein the length:width ratio is at least 2.0.

3-5. (canceled)

6. The coke of claim 1, wherein the length is between 2 and 36 inches and the width is between 1.5 and 12 inches.

7. The coke of claim 1, wherein the length is at least 4 inches.

8. The coke of claim 1, wherein the width is at least 3 inches.

9. A population of coke products produced from a single production process or from a single oven, wherein at least 30% of the total coke has an oblong shape, wherein the length is between 2 and 36 inches wherein the width is between 1.5 and 12 inches, and wherein the length:width ratio is at least 1.1.

10. The population of coke products of claim 9, wherein the coke products are produced by a horizontal oven.

11-27. (canceled)

28. The coke of claim 1, wherein the coke has a Coke Reactivity Index (CRI) of at least 20% and a Coke Strength after Reaction (CSR) less than 60%

29. The coke of claim 1, wherein the coke has a sulfur content less than 1.0%.

30. The coke of claim 1, wherein the fixed carbon content is at least 90%.

31. The coke of claim 1, wherein the coke has a moisture content of at least 1%.
